(19) United States
(12) Patent Application Publication
(10) Pub. No.: US 2010/0060542 A1
(43) Pub. Date: Mar. 11, 2010

(54) Multi-Band Antenna Arrangement

(75) Inventors: Ming Zheng, Farnborough (GB); Hanyang Wang, Abingdon (GB)

Correspondence Address: HARRINGTON & SMITH, PC, 4 RESEARCH DRIVE, Suite 202, SHELTON, CT, 06484-6212, US

(73) Assignee: NOKIA CORPORATION, Espoo (FI)

(21) Appl. No.: 11/632,090

(22) PCT Filed: May 6, 2005
(86) PCT No.: PCT/IB2005/001253

§ 371 Date: Nov. 23, 2009

(30) Foreign Application Priority Data
Jul. 20, 2004 (US) 10896212

(51) Int. Cl. H01Q 7/00; H01Q 1/48; H01Q 21/00; H01Q 1/36

(52) U.S. Cl. 343/843; 343/848; 343/866

(57) ABSTRACT

A multi-band antenna arrangement having a plurality of resonant modes and including a ground plane; and a first antenna forming a loop-like structure between a ground point and a feed point, wherein the first antenna is located in proximity to the ground plane and has resonant modes at X/2 and X.

### FIELD OF THE INVENTION

Embodiments of the present invention relate to a multi-band antenna arrangement. In particular, they relate to a multi-band antenna arrangement for a mobile cellular telephone.

### BACKGROUND TO THE INVENTION

In recent years, it has become desirable for cellular telephones to be able to communicate over multiple bands of the radio portion of the electromagnetic spectrum. This has arisen because different countries tend to use different frequency bands for cellular networks, for example, US WCDMA is at 850 MHz whereas EU WCDMA is at 2100 MHz. Even in a single country, different services may be provided at different radio frequency bands, for example, PCS is at 1900 MHz whereas PCN is at 1800 MHz. Consequently, cellular telephones require multi-band antenna arrangements that can allow them to communicate over a multiple bands of the radio portion of the electromagnetic spectrum.

Currently, multi-band antenna arrangements for cellular telephones comprise a plurality of antennas for communicating over the desired radio frequencies. Each antenna is connected to its own corresponding feed point and each is arranged to transmit and receive radio signals at a different radio frequency band. A switch is usually provided to selectively enable and disable the antennas so that the antenna arrangement can transmit and receive at a desired radio frequency bandwidth.

One problem associated with existing multi-band antenna arrangements is that they occupy a relatively large volume due to the number of antennas and feed points that are required to transmit and receive at the desired radio frequency bandwidth. Additionally, unwanted antenna coupling occurs due to electromagnetic interference between antennas which are in use and other antennas of the antenna arrangement which may deteriorate the performance of the multi-band antenna arrangement.

Therefore, it is desirable to provide an alternative multi-band antenna arrangement.

### BRIEF DESCRIPTION OF THE INVENTION

According to a first embodiment of the present invention there is provided a multi-band antenna arrangement having a plurality of resonant modes and comprising: a ground plane; and a first antenna forming a loop-like structure between a ground point and a feed point, wherein the first antenna is located in proximity to the ground plane and has resonant modes at λ/2 and λ.

The first antenna may have a further resonant mode at 3λ/2.

The first antenna may be directly fed via the feed point. Alternatively, the first antenna may be indirectly fed via the feed point.

A point approximately halfway between the ground point and the feed point of the first antenna may be proximal to the ground point and the feed point. This may form a ‘flattened’ loop-like structure.

The multi-band antenna arrangement may further comprise a second antenna that extends from the ground point. The second antenna may be proximal to but separated from the first antenna along at least of portion of its length. The second antenna may be electromagnetically coupled to the first antenna, along the portion of its length which is proximal to but separated from the first antenna, to provide a feed for the second antenna.

The first antenna may be electromagnetically coupled to the second antenna so that the λ/2 resonant mode of the first antenna electromagnetically couples with a λ/4 resonant mode in the second antenna.

The first antenna may be electromagnetically coupled to the second antenna so that the λ resonant mode of the first antenna electromagnetically couples with a λ/4 resonant mode of the second antenna.

The first antenna may be electromagnetically coupled to the second antenna so that the 3λ/2 resonant mode of the first antenna electromagnetically couples with a 3λ/4 resonant mode in the second antenna.

The first antenna may have an electrical length which is approximately twice the electrical length of the second antenna.

The second antenna may be proximal to the first antenna along its entire electrical length. The first antenna may be electromagnetically coupled to the second antenna so that the 3λ/2 resonant mode of the first antenna electromagnetically couples with a λ/4 resonant mode in the second antenna.

The first antenna may have a length which is approximately six times the electrical length of the second antenna.

According to a second embodiment of the present invention there is provided a multi-band antenna arrangement having a plurality of resonant modes and comprising: a feed point; a ground point; a ground plane; a first antenna connected to the ground point and the feed point to form a loop-like structure; a second antenna connected to the ground point and proximal to but separated from the first antenna along at least a portion of its length and, wherein the first antenna is located in proximity to the ground plane. The second antenna electromagnetically couples to the first antenna to provide a feed for the second antenna.

The first antenna may be proximal to the ground point and the feed point at a point approximately halfway between the ground point and the feed point. The first antenna may have λ/2, λ and 3λ/2 resonant modes.

The λ/2 resonant mode of the first antenna may electromagnetically couple with a λ/4 resonant mode of the second antenna. The λ or 3λ/2 resonant modes of the first antenna may electromagnetically couple with a 3λ/4 resonant mode of the second antenna. The first antenna may have an electrical length which is approximately twice the electrical length of the second antenna.

Alternatively, the 3λ/2 resonant mode of the first antenna may electromagnetically couple with a λ/4 resonant mode of the second antenna. The first antenna may have an electrical length which is approximately six times the electrical length of the second antenna.

According to a third embodiment of the present invention there is provided a transceiver device comprising an antenna arrangement as described in any of the preceding paragraphs.

### BRIEF DESCRIPTION OF THE DRAWINGS

For a better understanding of the present invention reference will now be made by way of example only to the accompanying drawings in which:

FIG. 1 illustrates a schematic diagram of a radio transceiver device comprising an antenna arrangement;

FIG. 2 illustrates a top down view of one embodiment of a multi-band antenna arrangement;

FIG. 3 illustrates a side view of the multi-band antenna arrangement illustrated in FIG. 2 when viewed along arrow A;

FIGS. 4A, 4B, 4C illustrate simplified electric field graphs for the resonant modes (0,0), (1,0) and (0,1) for the multi-band antenna arrangement illustrated in FIGS. 2 and 3.

FIG. 5 illustrates a graph of resonant frequencies for an antenna arrangement such as that illustrated in FIG. 2 and FIG. 3

FIG. 6 illustrates a top down view of a second embodiment of a multi-band antenna arrangement;

FIG. 7 illustrates a side view of the multi-band antenna arrangement illustrated in FIG. 6 when viewed along arrow A;

FIGS. 8A, 8B illustrate simplified electric field graphs for resonant modes (0), (1) of the PILA antenna illustrated in FIGS. 6 and 7;

FIG. 9 illustrates a graph of the resonant frequencies of the multi-band antenna arrangement illustrated in FIG. 6 and FIG. 7;

FIG. 10 illustrates a graph of efficiency versus frequency for the multi-band antenna arrangement illustrated in FIGS. 6 and 7; and

FIG. 11 illustrates a top down view of a third embodiment of a multi-band antenna arrangement.

### DETAILED DESCRIPTION OF EMBODIMENTS OF THE INVENTION

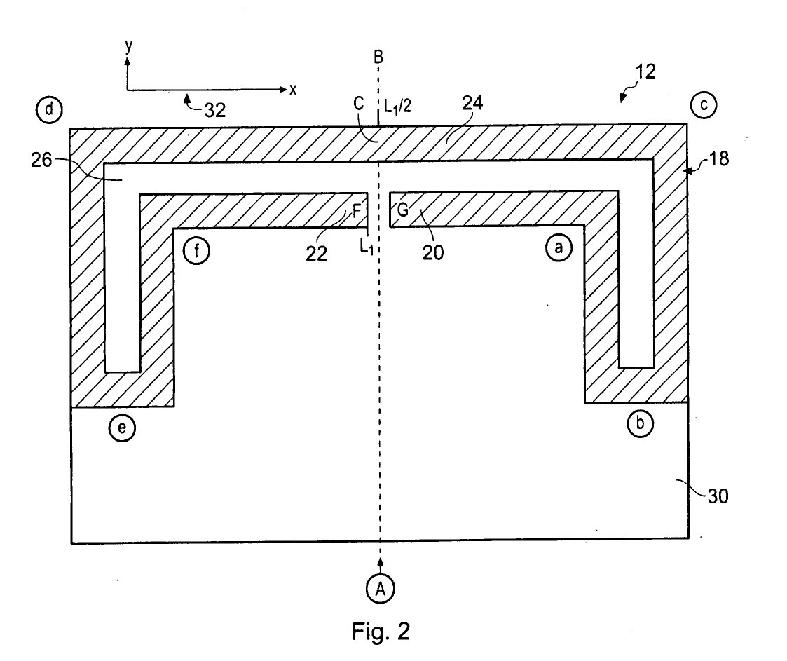

FIGS. 2, 3, 6, 7 and 10 illustrate a multi-band antenna arrangement 12 having a plurality of resonant modes and comprising: a ground plane 30; and a first antenna 18 forming a loop-like structure between a ground point 20 and a feed point 22, wherein the first antenna 18 is located in proximity to the ground plane 30 and has resonant modes at λ/2 and λ.

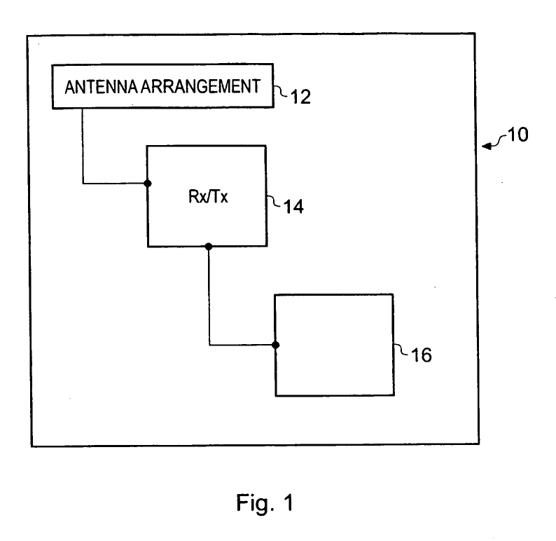

In more detail, FIG. 1 illustrates a radio transceiver device 10 such as a mobile cellular telephone, cellular base station, other radio communication device or module for such devices. The radio transceiver device 10 comprises a multi-band antenna arrangement 12, radio transceiver circuitry 14 connected to a feed point of the multi-band antenna arrangement 12 and functional circuitry 16 connected to the radio transceiver circuitry 14. In the embodiment where the radio transceiver device 10 is a mobile cellular telephone, the functional circuitry 16 includes a processor, a memory and input/output devices such as a microphone, a loudspeaker and a display. Typically the electronic components that provide the radio transceiver circuitry 14 and functional circuitry 16 are interconnected via a printed wiring board (PWB). The PWB may be used as a ground plane for the multi-band antenna arrangement 12.

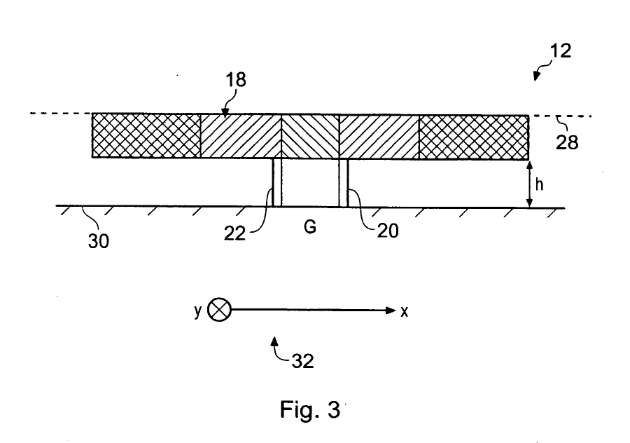

FIGS. 2 and 3 illustrate a multi-band antenna arrangement 12 including an antenna 18. The antenna 18 is a planar folded monopole, folded dipole antenna and has a plurality of operational resonant frequencies. The particular antenna illustrated has three resonances that respectively cover the GSM band (900 MHz), the PCN band (1800 MHz) and the PCS band (1900 MHz). The antenna 18 is particularly suited for use as an internal antenna of a mobile cellular radio terminal, such as a mobile telephone.

The antenna 18 is loop-like having a single ground point 20 adjacent a single feed point 22 and a single antenna track 24 that extends from the ground point 20 to the feed point 22 in a single loop-like structure. In one embodiment, the antenna 18 is directly fed via the feed point 22. In another embodiment, the antenna 18 is indirectly fed via the feed point 22, for example, by electromagnetic coupling.

The structure of the antenna 18 is non-circular and encloses an area of space 26. The antenna track 24 has a number of right angled bends (=90°) and lies in a flat geometric plane 28, which is, in this embodiment, located above and is parallel to a ground plane 30. The antenna 18 is located in proximity to the ground plane 30. For example, the antenna 18 may be adjacent the ground plane 30, at least partially overlap the ground plane 30 or be inclined at an angle to the ground plane 30. The antenna 18 may be mounted on a module which is dependent upon the handset shape. The proximity of the antenna 18 to the ground plane 30 results in electromagnetic coupling between them which allows (at least in part) the antenna 18 to function as a folded monopole, folded dipole antenna. The antenna track 24 is, in this embodiment, substantially symmetric about the line B and has a constant width. The antenna track 24 has an electrical length L₁. The separation h₁ between the antenna track 24 and the ground plane 30 can be made of the order of a few millimetres.

A co-ordinate system 32 is included in FIGS. 2 and 3. The co-ordinate system 32 comprises an x vector that is orthogonal to a y vector. The feed point 22 is displaced from the ground point 20 in a −x direction.

The single antenna track 24 extends away from the ground point 20 in a +x direction, makes a right-angled right bend at point (a) and then extends in a −y direction. The antenna track 24 then makes two right-angled left bends at point (b) so that it extends in the +y direction. The antenna track 24 then makes a right-angled left bend at point (c) and extends in a −x direction past the ground point 20 and feed point 22. The antenna track then makes a right-angled left bend at point (d) and then extends in a −y direction. The antenna track 24 then makes two right-angled left hand bends at point (e) and then extends in a +y direction. The antenna track 24 then makes a right-angled right bend at point (f) and extends in a +x direction to the feed point 22.

The antenna track 24 is proximal to the ground point 20 and the feed point 22 at point C. Point C is approximately halfway between the ground point 20 and the feed point 22 and is therefore at a distance L₁/2 from the ground point 20. Due to the proximity of the antenna track 24 to the feed point 22 and the ground point 20 at point C, the antenna track 24 is capacitively loaded in the vicinity of point C at L₁/2 for folded monopole modes.

As mentioned above, the antenna 18 is a planar folded dipole, folded monopole antenna. As a folded dipole, the antenna 18 may be seen as being divided into two parallel λ/2 dipoles, each having a length L₁/2 and connected at their four open ends. Consequently, the antenna 18 has a resonant mode at λ over its length L₁ but can also be viewed as having a resonant mode at folded λ/2. The resonant modes of a folded dipole may be represented by:

L₁=n_{d}×λ

where n_{d} is a whole number representing a resonant folded dipole mode and λ is an electromagnetic wavelength of the resonant frequency for that mode. There is no resonant mode when n_{d}=0.

As a folded monopole, the antenna 18 may be seen as being divided into two parallel λ/4 monopoles, each having a length L₁/2 and connected at their two open ends. Consequently, the antenna 18 has a resonant mode at λ/2 or 3λ/2 over its length L₁, but can also be viewed as having a resonant mode at folded λ/4 or folded 3λ/4 respectively. The resonant modes of a folded monopole may be represented by:

$${L}_{1} = ( 2 {n}_{m} + 1 ) \times \frac{λ}{2}$$

where nₘ is a whole number representing a resonant folded monopole mode and λ is an electromagnetic wavelength of the resonant frequency for that mode.

The position (y_{d}) from the ground point 20 of maximum electric field (Eₘₐₓ) for a folded dipole may be given by:

$${y}_{d} = \frac{( 2 \times {a}_{d} - 1 )}{{n}_{d}} \times \frac{{L}_{1}}{4}$$

$$where {a}_{d} = 1 , … , 2 {n}_{d} .$$

The position (yₘ) from the ground point 20 of the maximum electric field (Eₘₐₓ) for a folded monopole may be given by:

$${y}_{m} = \frac{( 2 \times {a}_{m} - 1 )}{( 2 \times {n}_{m} + 1 )} \times \frac{{L}_{1}}{2}$$

$$where {a}_{m} = 1 , … , 2 {n}_{m} + 1.$$

The table below sets out the lower 3 modes of the folded monopole, folded dipole antenna 18 and the maximum E field positions. Each mode may be conveniently referred to as (n_{d}, nₘ). The wavelength corresponding to the resonant frequency of a mode (n_{d}, nₘ) may be conveniently referred to using λ_{nd nm}.

It should be noted, that for modes where n_{d}>0 and nₘ=0, the position of Max E field is given by y_{d} and not yₘ. It should be noted, that for modes where n_{d}=0, the position of Max E field is given by yₘ and not y_{d}.

| | | | | Max E field |
|---|---|---|---|---|
| n_{d} | nₘ | λ_{nd nm} | Frequency | position |
| 0 | 0 | 2L₁ | 1/2 * 1/L₁* c | L₁/2 |
| 1 | 0 | L₁ | 1/L₁* c | L₁/4, 3L₁/4 |
| 0 | 1 | 2L₁/3 | 3/2* 1/L₁* c | L₁/6 L₁/2 |
| | | | | 5L₁/6 |

c: velocity of electromagnetic wave

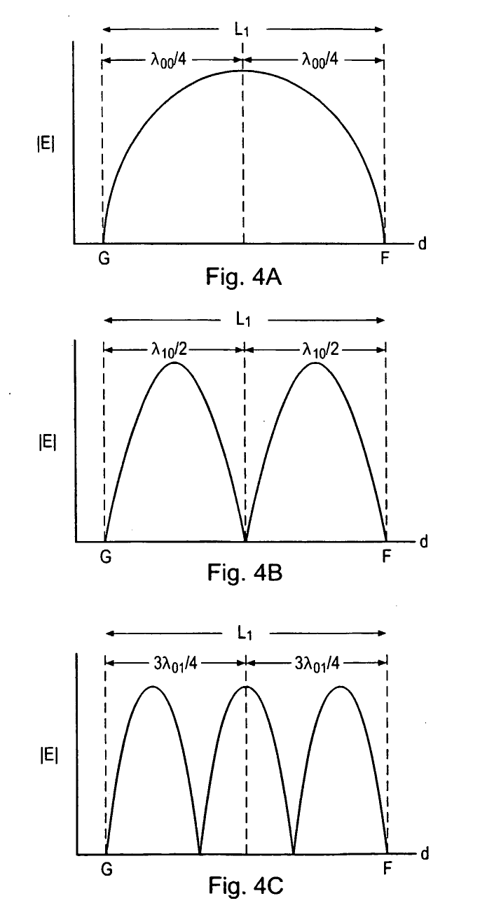

As illustrated in FIG. 4A, in the (0,0) mode the antenna 18 operates as two λ/4 monopole structures connected at the max E field position L₁/2. λ₀₀ corresponds to 2L₁. As illustrated in FIG. 4B, in the (1, 0) mode the antenna operates as two λ/2 dipole structures which are connected in parallel at positions coincident with the maximum E field positions L/4 and 3L/4. λ₁₀ corresponds to L₁. As illustrated in FIG. 4C, in the (0,1) mode the antenna operates in a resonant mode of two λ3/4 monopole structures connected at max E field position L₁/2. λ₀₁ corresponds to 2L₁/3.

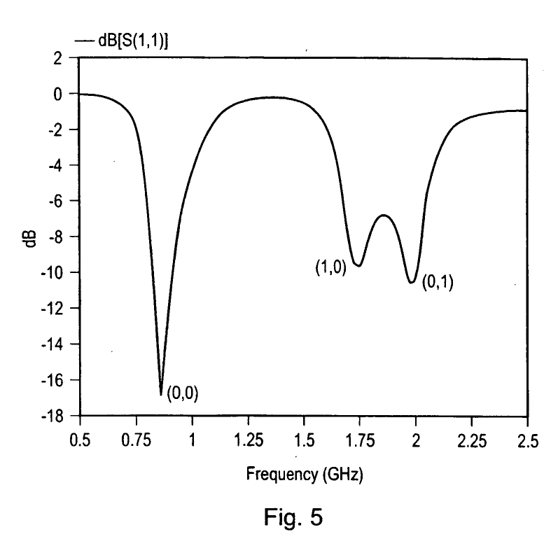

Capacitive loading at the position from the ground point of maximum electric field (Eₘₐₓ) for a mode, reduces the resonant frequency of that mode. The capacitive loading at L₁/2, as mentioned above, of the antenna 18 reduces the resonant frequency of the folded monopole modes (0,0), (0,1). The capacitative loading at L₁/2 increases the resonant frequency of the folded dipole mode (1,0) because it reduces the inductance at L₁/2. The resonant modes (0,0), (1,0) and (0,1) for the loaded, planar, folded monopole, folded dipole antenna are illustrated in FIG. 5.

The (0,0) mode has a resonant frequency at 900 MHz which is suitable for GSM.

The (1,0) mode has a resonant frequency at 1800 MHz and is suitable for PCN.

The (0,1) mode has a resonant frequency at 1900 MHz and is suitable for PCS and US WCDMA.

The antenna 18 must satisfy some electromagnetic boundary conditions. The electrical impedance at the feed point is close to 50 Ohm and the electrical impedance at the ground point is close to 0 Ohm. The antenna 18 is also optimised to obtain an acceptable return loss (e.g. 6 dB) at the cellular bands.

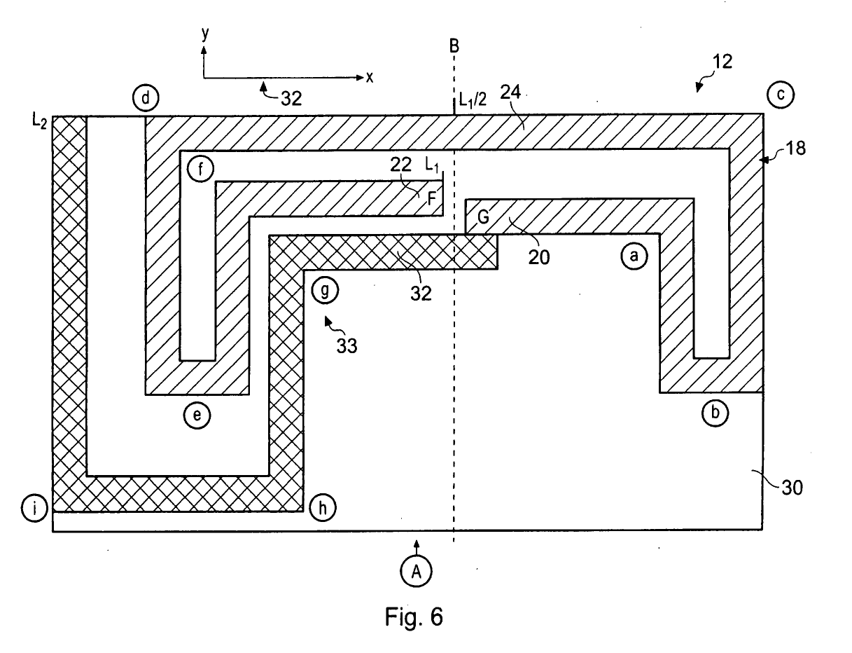

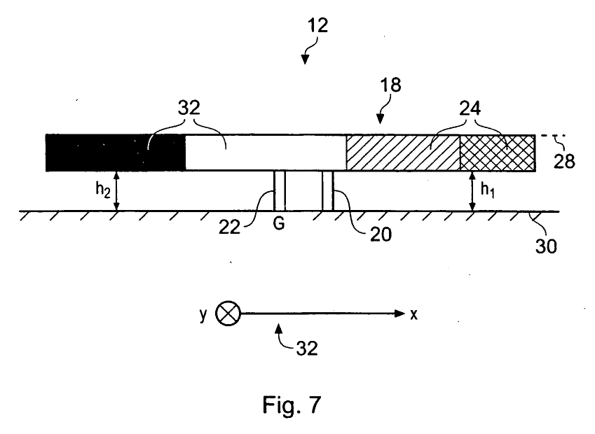

FIGS. 6 and 7 illustrate a second embodiment of the present invention. In this embodiment, the multi-band antenna arrangement 12 includes a first antenna 18 and a second antenna 32. The first antenna 18 is substantially the same as the antenna 18 illustrated in FIGS. 2 and 3 and where the features are similar, the same reference numerals are used. The second antenna 32 has two resonances that respectively cover the US GSM and US WCDMA bands (850 MHz) and the EU WCDMA band (2100 MHz).

The second antenna 32 is, in this embodiment, a planar inverted L antenna (PILA) having an electrical length L₂. The PILA 32 is connected to the ground plane 30 via the ground point 20. Consequently, the first antenna 18 and the PILA 32 share the same ground point. At least a portion 33 of the PILA 32 is proximal to the first antenna 18. In the example illustrated the portion 33 and the first antenna 18 run in parallel and are separated by the order of from one-tenth of a millimetre to several millimetres. As will be explained in greater detail in the following paragraphs, the PILA 32 is electromagnetically coupled to the first antenna 18 and is consequently not directly electrically connected to a feed point.

The PILA 32 has a number of right-angled bends (=90°) and lies in the flat geometric plane 28, which is parallel to the ground plane 30. The separation h₂ between the antenna 32 and the ground plane 30 can be made of the order of a few millimetres, and is typically the same as h₁.

The PILA 32 extends from the ground point 20 in a −x direction and makes a right-angled left turn at point (g). The PILA 32 then extends in a −y direction and makes a right-angled right turn at point (h). The PILA 32 then extends in a −x direction and makes a right-angled right turn at point (i). The PILA 32 then extends in a +y direction for the remaining portion of its length L₂. In this embodiment, the PILA 32 is proximal to the first antenna 18 between the ground point 20 and the point (g) and for approximately two thirds of the length between points (g) and (h). Consequently, the PILA 32 is proximal to the first antenna 18 for approximately ⅓rd of its electrical length L₂.

The PILA 32 is electromagnetically coupled to the first antenna 18, for example, where it is proximal to the first antenna 18. Consequently, when the first antenna 18 has a current flowing through it, it electromagnetically (either capacitively or inductively) couples with the PILA 32 to produce a current in the PILA 32. Therefore, the first antenna 18 acts as a feed for the PILA 32.

The PILA 32 may be viewed as a monopole antenna. The resonant modes of a monopole antenna may be represented by:

$$L = ( 2 {n}_{p} + 1 ) \times \frac{λ}{4}$$

where nₚ is a whole number representing a monopole mode and λ is a electromagnetic wavelength of the resonant frequency for that mode.

The position (yₚ) from the ground point of the maximum electric field (Eₘₐₓ) for a monopole may be given by:

$${y}_{p} = \frac{( 2 {a}_{p} - 1 )}{( 2 {n}_{p} + 1 )} \times L$$

$$where {a}_{p} = 1 , … , {n}_{p} + 1.$$

The table below sets out the two lower modes of the PILA 32 and the maximum E field positions. Each mode may be conveniently referred to as (nₚ). The wavelength corresponding to the resonant frequency of a mode (nₚ) may be conveniently referred to using λₙₚ.

| | | | Max E field |
|---|---|---|---|
| nₚ | λₙₚ | Frequency (Hz) | position |
| 0 | 4L₂ | (1/4L₂) × c | L₂ |
| 1 | 4L₂/3 | (3/4L₂) × c | 1/3 L₂, L₂ |

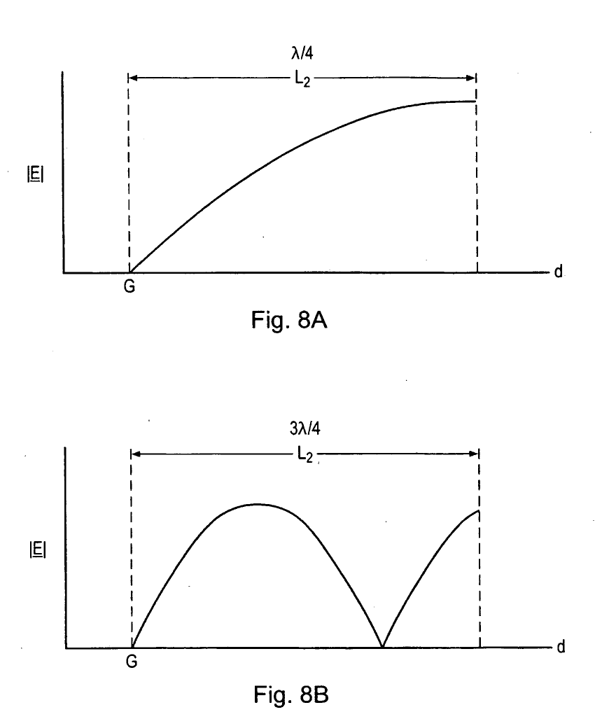

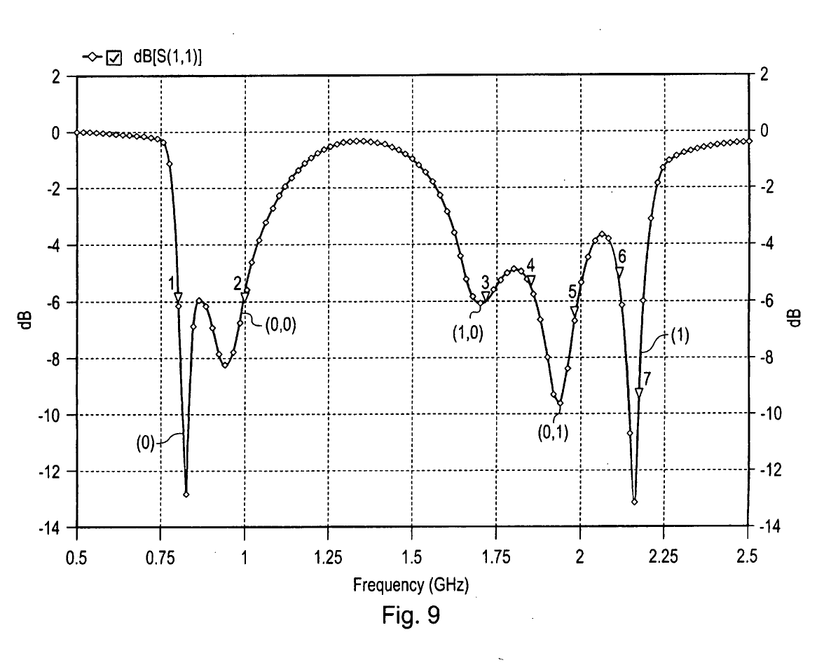

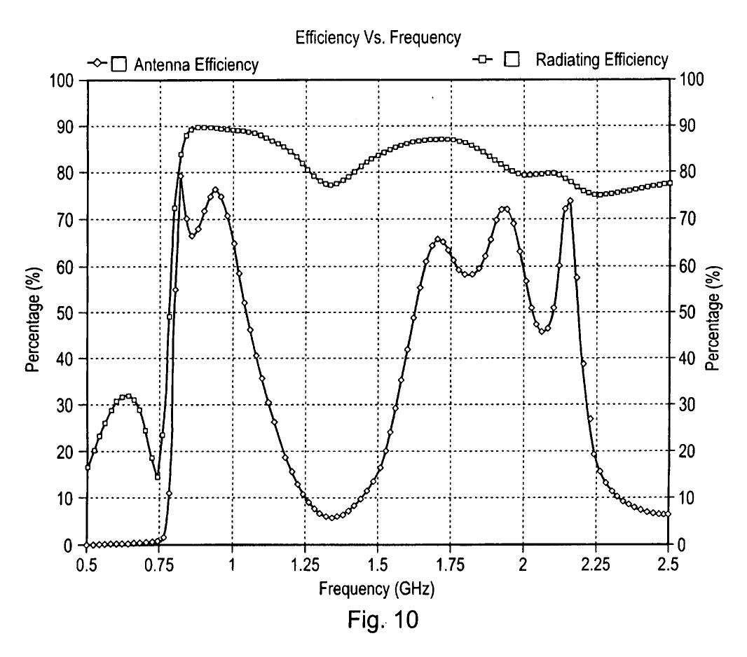

As illustrated in FIG. 8A, in the (0) mode (nₚ=0), the PILA 32 operates so that the maximum E field position is L₂. As illustrated in FIG. 8B, in the (1) mode (nₚ=1), the PILA 32 operates so that the maximum E field positions are L₂/3 and L₂. The resonant modes nₚ=0 and nₚ=1 of the PILA antenna 32 as well as the resonant modes of the first antenna 18 are illustrated in FIG. 9. FIG. 10 illustrates a graph of efficiency versus frequency for the multi-band antenna arrangement 12 illustrated in FIGS. 6 and 7.

The first antenna 18 and the PILA 32 are electromagnetically coupled. The (0,0) mode of the first antenna 18 electromagnetically couples with the (0) mode of the PILA 32. The (0,1) mode of the first antenna 18 electromagnetically couples with the (1) mode of the PILA 32.

To achieve this electromagnetic coupling, the electrical length L₁ of the first antenna 18 is approximately twice the electrical length of the PILA 32. This results in the resonant frequencies for the modes being approximately the same. In this implementation the electrical length Lᵢ of the first antenna 18 is slightly less than twice the electrical length of the PILA 32.

In an alternative embodiment, the (0,0) mode of the first antenna 18 electromagnetically couples with the (1) mode of the PILA 32. In this embodiment, the electrical length of the PILA 32 is one and a half times the length of the first antenna 18.

In another embodiment, the (1,0) mode of the first antenna 18 electromagnetically couples with the (1) mode of the PILA 32. In this embodiment, the electrical length of the PILA 32 is ¾ times the electrical length of the first antenna 18.

The resonant modes of the first antenna 18 ((0,0), (1,0) and (0,1)) are substantially the same as the resonant modes illustrated in FIG. 5: The (0) mode of the PILA 32 (nₚ=0) has a resonant frequency bandwidth at 850 MHz (824 to 894 MHz) which is suitable for GSM and US WCDMA. The (1) mode (nₚ=1) of the PILA 32 has a resonant frequency bandwidth at 2100 MHz (2110 to 2170 MHz) which is suitable for EU WCDMA.

One advantage provided by the antenna arrangement 12 illustrated in FIGS. 6 & 7 is that it provides five operational resonant frequencies which may be used for cellular communication. The antenna arrangement 12 also only uses a single feed point. One advantage provided by this feature is that the antenna arrangement 12 suffers little or none unwanted antenna coupling between separate antenna structures as outlined in the Background to the Invention. Furthermore, antenna elements and feed points occupy space in an antenna arrangement and consequently, the antenna arrangement 12 may occupy less space in a cellular phone because it only uses two antenna elements and one feed point. Additionally, having a single feed point may reduce the cost and manufacturing complexity of the antenna arrangement.

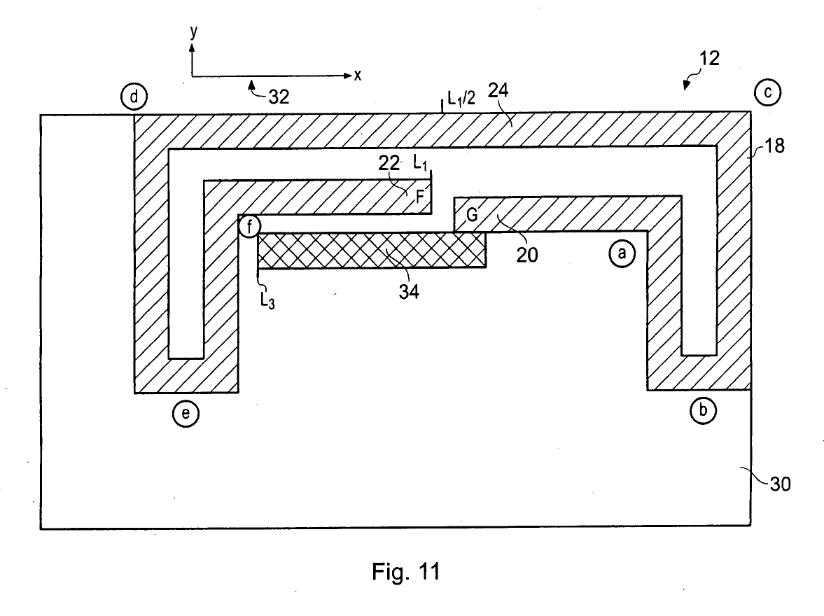

FIG. 11 illustrates a third embodiment of a multi-band antenna arrangement 12. In this embodiment, the multi-band antenna arrangement 12 includes a first antenna 18 and a third antenna 34. The first antenna 18 is substantially the same as the antenna 18 illustrated in FIGS. 2, 3, 6 and 7 and where the features are similar, the same reference numerals are used. The third antenna 34 has one resonant mode that covers the EU WCDMA band (2100 MHz).

The third antenna 34 is, in this embodiment, a planar inverted L antenna (PILA) having an electrical length L₃. The PILA 34 is connected to the ground plane 30 via the ground point 20. Consequently, the first antenna 18 and the PILA 34 share the same ground point. In this embodiment, the entire electrical length L₃ of the PILA 34 is proximal to the first antenna 18. The PILA 34 is electromagnetically coupled to the first antenna 18 and is consequently not directly electrically connected to a feed point.

The PILA 34 is substantially straight and lies in a flat geometric plane which is parallel to the ground plane 30. The separation between the PILA 34 and the ground plane 30 can be made of the order of a few millimetres. The PILA 34 extends from the ground point 20 in a −x direction for its entire length L₃. The PILA 34 is electromagnetically coupled to the first antenna 18 along its entire electrical length L₃ (as mentioned above). Consequently, when the first antenna 18 has a current flowing through it, it electromagnetically (either capacitively or inductively) couples with the PILA 34 and produces a current in the PILA 34. Therefore, the first antenna 18 acts as a feed for the PILA 34.

The PILA 34 nₚ=0 mode is electromagnetically coupled to the (0,1) mode of the first antenna 18, ie. L₃=/4. The resonant frequency of this mode is 2100 MHz (2110 to 2170 MHz) and is suitable for EU WCDMA. To achieve this electromagnetic coupling, the electrical length L₁ of the first antenna 18 is approximately six times the electrical length of the PILA 34. This results in the resonant frequencies for the modes being approximately the same. In this implementation, the electrical length L₁ of the first antenna 18 is slightly less than six times the electrical length of the PILA 34.

The antenna arrangement 12 illustrated in FIG. 11 may occupy less volume than the antenna arrangement 12 illustrated in FIGS. 6 and 7 and may be more preferable where volume within a device is limited.

Although embodiments of the present invention have been described in the preceding paragraphs with reference to various examples, it should be appreciated that modifications to the examples given can be made without departing from the spirit and scope of the invention. For example, the first antenna 18 may be any folded dipole, folded monopole antenna and the second and third antennas may be any unbalanced antenna.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I\we claim:

1. A multi-band antenna arrangement having a plurality of resonant modes and comprising:
a ground plane; and
a first antenna forming a loop like structure between a ground point and a feed point, wherein the first antenna is located in proximity to the ground plane, has an electrical length (L) that is substantially equal to the distance along the first antenna between the feed point and the ground point and has resonant modes at L=λ/2 and L=λ.

2. A multi-band antenna arrangement as claimed in claim 1, wherein the first antenna has a further resonant mode at L=3λ/2.

3. A multi-band antenna arrangement as claimed in claim 1, wherein the first antenna is directly fed via the feed point or indirectly fed via the feed point.

4. A multi-band antenna arrangement as claimed in claim 1, wherein the first antenna is proximal to the ground point and the feed point at a point approximately halfway between the ground point and the feed point.

5. A multi-band antenna arrangement as claimed in claim 1, further comprising a second antenna that extends from the ground point and is proximal to the first antenna along at least of portion of its length.

6. A multi-band antenna arrangement as claimed in claim 5, wherein the second antenna is electromagnetically coupled to the first antenna, along the portion of its length which is proximal to the first antenna, to provide a feed for the second antenna.

7. A multi-band antenna arrangement as claimed in claim 5, wherein the electrical length of the first antenna is approximately twice the electrical length of the second antenna.

8. A multi-band antenna arrangement as claimed in claim 7, wherein the first antenna is electromagnetically coupled to the second antenna so that the L==λ/2 resonant mode of the first antenna electromagnetically couples with a λ/4 resonant mode in the second antenna.

9. A multi-band antenna arrangement as claimed in claim 7, wherein the first antenna is electromagnetically coupled to the second antenna so that the L==3λ/2 resonant mode of the first antenna electromagnetically couples with a 3λ/4 resonant mode in the second antenna.

10. A multi-band antenna arrangement as claimed in claim 6, wherein the second antenna is proximal to the first antenna along its entire electrical length.

11. A multi-band antenna arrangement as claimed in claim 10, wherein the electrical length of the first antenna is approximately six times the electrical length of the second antenna.

12. A multi-band antenna arrangement as claimed in claim 11, wherein the first antenna is electromagnetically coupled to the second antenna so that the L==3λ/2 resonant mode of the first antenna electromagnetically couples with a λ/4 resonant mode in the second antenna.

13. A multi-band antenna arrangement having a plurality of resonant modes and comprising:
a feed point;
a ground point;
a ground plane;
a first antenna connected to the ground point and the feed point to form a loop-like structure, wherein the first antenna is located in proximity to the ground plane, has an electrical length (L) that is substantially equal to the distance along the first
antenna between the feed point and the ground point, and has resonant modes at L==λ/2 and L=λ;
a second antenna connected to the ground point and proximal to the first antenna along at least a portion of its length, wherein the second antenna is electromagnetically coupled to the first antenna along the portion of its length which is proximal to the first antenna to provide a feed for the second antenna.

14. A multi-band antenna arrangement as claimed in claim 13, wherein the first antenna is proximal to the ground point and the feed point at a point approximately halfway between the ground point and the feed point.

15. A multi-band antenna arrangement as claimed in claim 13, wherein the first antenna has a resonant mode at L==3λ/2.

16. A multi-band antenna arrangement as claimed in claim 13, wherein the electrical length of the first antenna is approximately twice the electrical length of the second antenna.

17. A multi-band antenna arrangement as claimed in claim 16, wherein the L=λ/2 resonant mode of the first antenna electromagnetically couples with a λ/4 resonant mode of the second antenna.

18. A multi-band antenna arrangement as claimed in claim 16, wherein the L=3λ/2 resonant mode of the first antenna electromagnetically couples with a 3λ/4 resonant mode of the second antenna.

19. A multi-band antenna arrangement as claimed in claim 13, wherein the second antenna is proximal to the first antenna along its entire electrical length.

20. A multi-band antenna arrangement as claimed in claim 13, wherein the electrical length of the first antenna is approximately six times the electrical length of the second antenna.

21. A multi-band antenna arrangement as claimed in claim 20, wherein the L=3λ/2 resonant mode of the first antenna electromagnetically couples with a λ/4 resonant mode of the second antenna.

22. A transceiver device comprising an antenna arrangement as claimed in claim 1.

23. (canceled)
